(19) United States
(12) Patent Application Publication
(10) Pub. No.: US 2024/0299982 A1
(43) Pub. Date: Sep. 12, 2024

(54) MATERIAL SEPARATION BY DENSITY

(71) Applicant: Federico Marquez Lopez, Chihuahua (MX)

(72) Inventor: Federico Marquez Lopez, Chihuahua (MX)

(21) Appl. No.: 18/264,478

(22) PCT Filed: Mar. 1, 2022
(86) PCT No.: PCT/US2022/018373

§ 371 Date: Aug. 7, 2023

Related U.S. Application Data
(60) Provisional application No. 63/155,389, filed on Mar. 2, 2021.

(51) Int. Cl. B07B 4/02; B07B 11/02

(52) U.S. Cl. CPC B07B 4/02; B07B 11/02

(57) ABSTRACT

Disclosed is a particle separation method for separating particles from a mixture. Particles are processed with simultaneous forces acting on particle mass and particle size. The particles are processed by free fall of particles into a side wind or gas flow, to separate the particles by density, establishing the gas flow velocity to reach a distance point of separation of the materials by density. The particles are separated into lots of similar size difference to prevent mixing of bigger particles of low density with small particles of high density based on the processing of the materials.

### CROSS-REFERENCE TO RELATED PATENT DOCUMENTS

This application is a national stage entry of PCT/US2022/018373 filed Mar. 1, 2022, under the International Convention and claiming priority over U.S. Provisional Application No. 63/155,389, entitled Material Separation by Density,” filed 2 Mar. 2021, which are hereby incorporated herein by reference in its entirety.

### FIELD OF THE INVENTION

The present invention relates generally to material separation, and, more particularly, to a method and a system for mineral separation from a mixture by using their density. The mineral separation process is developed based on a physical process instead of a chemical process. The mineral separation process capitalizes terminal velocity and specific gravity of each mineral for the separation.

### BACKGROUND OF THE INVENTION

Generally, we use various types of minerals or materials daily. Obtaining of these minerals or materials that are being used on daily basis is a complex process. Mining is extraction of valuable minerals or other geological materials from the earth, usually from an orebody, lode, vein, seam, reef, or placer deposit. These deposits form a mineralized package that is of economic interest to the miner. Mining is required to obtain any material that cannot be grown through agricultural processes or created artificially in a laboratory or factory. Thus, mining is more than finding where the desired resources are available.

Resources are available in many places and some of the minerals or materials almost in all places. Its abundance is what changes from every material and the specific concentration of each material. Some of the materials are of very low concentrations like gold for which the extraction is sometimes as little as 1 PPM (Particle Per Million) i.e., one gram of gold is present in every ton of natural materials. So, most of the effort is in getting that one gram apart from the rest of the materials. Traditionally, methods like lixiviation and flotation are used to obtain the desired material and are intense in the use of chemicals. Most of these processes are chemically targeted to a specific mineral or material that is desired to be extracted. Gravitational concentration is known from long time, and it allows to concentrate the desired minerals or materials by the density difference, like the Wilfred table or the cyclone, or hydro cyclone. In the past, gravimetric concentrators were thought to be working on the principle of buoyancy. The previous processes set the terminal velocity as a method to separate the particles in the material, each particles different density made a different velocity, and considering that velocity difference in a time becomes distance difference, allowing the separation by the distance in the fluid dynamics, for example, it worked with water. Now after more time experimentation it was made in a dry process avoiding using water, and making a constant process, increasing the capability for industrial use and production speed. This process will now be described in detail in this disclosure to illustrate various applications and advantages of mineral separation.

### SUMMARY OF THE INVENTION

As this innovation may look similar in geometry, coincidence in some components use and may have the exact objective of many previous inventions, the small differences make a huge difference in the result of efficiency and recovery of desired materials, while making them of better grade or purity of all previous or similar, so a deeper explanation is made without changing the essence or reach of PCT patent, and just explaining.

In specific in mining the minerals or materials, have a specific gravity or density, for example quartz, that can be used to make glass, have 2.7 gram/cm3 specific density approximately, while clay that can be used for pottery or ceramics may have 2.4 gram/cm3, and most time they are mixed in the same ore, this very small difference of density can be used in this new method here provided with great, recovery and grade while previous methods of very high similarity do not provide the same great capabilities generated by the very small difference in the process, and advance is given by results and use, not complexity.

Minerals have each one with its specific gravity some with similarity, btu with difference enough most times to be separated from the contaminants or other useful materials if they are separated, and this using just physical forces not affecting chemically the environment. Some examples Chalcopyrite or Malachite containing copper may have density higher than 6 gram/cm3, and might be just 0.5% of an ore probably predominantly made of quartz as said about 2.7 gram/cm3, making a great advance for better physical extraction and lower chemical damage, even when used in combination to chemical methods.

An object or a particle mass will depend on its size and its density so previous classification on size into an identical or vary similar size, is to make the mass of all and each particle in the material to differentiate in mass to other, only by density difference not also size difference, so the force gravity exert on it, to depend on density difference of particles, and not size, makes to isolate physical phenomenas dependable on density (specific gravity) in efficient way, never seen, as it is hard to have exact size, the size fractions of minor and mayor size definitions or limits to be almost the same is given by math.

Normal mining can be mesh 200 that is about 150 microns larger size and maybe 20 microns smaller particle size, that is ratio of more than 12 bigger to smaller, while density in minerals do not reach that difference and the particle diameter difference has a cubic effect as mass is given not by diameter but by cubic (volumetric) effect of ratio, so it was needed this to have efficiency, and not previously disclosed, that is part of a discovery of the physical phenomena of physical separation by density to be improved.

For example, U.S. Pat. No. 4,486,300—SPECIFIC GRAVITY GRAIN GRADER has a very similar geometry and function, while the main difference to it is, they do not make previous size classification to before cross flow, distance reach of particles, and propulsion motor control to have the exact fluid velocity for particles of desired specific gravity (density) reach the distance of separation while higher density particles reach lower distance not reaching the distance to separation.

Also EP1331045—SORTING METHOD AND APPARATUS FOR BREAKING UP FORAGE PLANTS, PARTICULARLY ALFALFA, INTO THEIR COMPONENTS AND PRODUCT OBTAINABLE THEREWITH, makes a similar geometry of lateral fluid, there it is described as pneumatic, without making a size classification prior to it, so the downward force given by gravity, will be defined by size difference also and not just density (specific gravity) difference alone.

And we can find many that have some similarity the truth the principle is called cross flow and by itself is not a novelty and while different geometries could make innovation to it, its similarity in partial do not either create similar results or deteriorates novelty of new combination with use of other principles for higher efficiency.

While there are many inventions using cross flow as a separation method or principle, its implementation in different way has different uses and the main difference of this innovation is the discover of the exact function, of physics in the phenomena, to specify a simple step of preliminary size classification to isolate the particle mass difference into just density difference, in few words maybe we all remember the joke, which weights more a kilogram of feathers or a kilogram of rocks?, well the wight is the exact same, and they have the exact same gravity force, but now the question is; which one does weight more a gallon (volume 3.6 litter) of feather or a gallon of rock?, so rock obvious, but the size standardization now allow to have a gravity force difference between the two materials and now we can calculate exactly how far each one reaches under the cross flow of wind, (fluid) at an exact given velocity of wind, in fluid of exact viscosity (friction that define drag force given stokes law), and exact size (gallon for both), making both particles pushing sideway, while downward force given gravity is different in mass given that feathers have lower density, and we can define exact point of reach for each, this needs the gallon to be solid for both materials, or it would change conditions, so that is why particle size classification prior the process makes the huge difference of efficiency.

Cross flow as separation method, do not have just an effect of distance or trajectory given the density of its fragments or particles, as mention size matters and it can be explained under exact calculation with stokes low or other drag force calculation, and to easily understand this all called gravity or density separators of this type when used as traditionally been done, have a size result effect in the separated material, and some even are made for this specific purpose, like grain classifiers that it is expected for grains to have very similar density and the effect of cross flow, results in a size difference, this can be seen in so many air classifiers actually used, for example the patent, DE000010196610—VORRICHTUNG ZUR SORTIERUNG VON HOLZSCHNITZELN IN SEPARATE FRAKTIONEN is specifically made for separation of fines or small fragments or particles, so the main difference, of this innovation is to pre classify particles into same or similar size difference to isolate mass difference of each particle into density, and the control of velocity of the fluid (air expected) for particles below the defined specific gravity (for example clay at 2.4 gram/cm3) to reach the distance of separation, while other of higher specific gravity (density), like for example quartz at 2.7 gram/cm3, fall faster and do not reach the distance of separation, this having the fluid velocity controlled to the exact velocity for that given, viscosity, size fraction difference, distance of separation, and height of column fall, to be exactly separated at that distance of separation.

It is an objective of the present invention to provide a method and a system for separating particles from a mixture by density. A particle can be moved by a lateral force. Such force on the particle may be calculated. Further, speed of the particle may be determined using Stokes Law that defines the speed of the particle as terminal velocity.

The terminal velocity is defined by the density of the fluid, the density of the particle, the size of the particle, and the viscosity of the fluid. The terminal velocity is the maximum velocity an object (such as a particle) can reach given a moving force through a fluid resistance. Upon classification of particles into similar or same size lots, the particles are put into movement by the lateral force. The particles of different density will have different velocity (i.e., the terminal velocity). With the particles of higher density and similar size, the particles exhibit an efficient gravitational process for separating by the density, and by the complete process of the present invention, both the accuracy and the efficiency may be improved, making concentrations of particles by their densities.

After making experiments and calculations, it has been further found that it is not even necessary to reach terminal velocity or make it in that way. The terminal velocity is the resulting top speed of an object moved by a force and receiving the drag force of a fluid limiting its movement. The process uses the gravity force moving the object (particles or minerals) which affects it in relation to its mass and drag force of a fluid that restraints its movement given the object (particle) size, finishing in a final top velocity. From this, it became other methods looking for faster production, and using air as more abundant source, fining that if the material is put into a force or forces affecting it by its mass (weight), and by a force affecting it by its size, then it provides a result force and direction that is relative to its mass to size relation. If we remember density is a mass to size relation, for example kg/ton, so it was found that under this, each particle of the material processed by the same conditions will have a different trajectory, distance, direction, or path that is dependent on its mass to size relation or said in other words, it is dependent on each particle density, making it possible to separate the material particles by each particle density.

Mass of each particle (i.e., weight of each particle) in the material is established by the size of the particle and the density of it, so it could be possible that two particles of different density can have the same mass or weight, if the size difference compensates the density difference, in easier explain, a big particle with low density may weigh the same or more than a small particle of high density. This is important to notice as that simple understanding allows to discover that they could mix in this process, as the forces that affect the particle by mass do not affect the particle in an identical way to the forces affecting it by its size, so the forces are dependent on mass and size, not directly density. So the process is only valid for particles in a size range, so coincidence of resulting distance, path or trajectory of particles of different density is possible providing lower efficiency, recovery and yield (concentration), this can be solved and to prevent this, it is needed the separation by size prior to processing it by the simultaneous force affecting the particle by its mass and also force affecting it by its size, in this way size becomes similar to a constant and avoids the coincidence of particles of different density, increase efficiency, and increase concentration. For determining a range of particle size to prevent the described collisions, it is easy by calculation and is dependent on density difference and specific geometry of the working machine to separate them and the operating conditions, so it is particular for every processing need and, in few word it is ideal when the size difference affects in lower way the final distance, trajectory or path of each particle processed than the effect of the density difference, avoiding the desired processed material to contain undesired density particles. The size difference must be in a way so that the resulting distance, trajectory, or path is affected in a higher grade by density difference of the target densities to separate. The distance, trajectory, or path may be calculated in different ways, the formulas exist for any given force, gravity, inertia, fluid drag, and others acting on the particle, for example, the terminal velocity considers it and is defined in Stokes Law, the forces effect can be modeled depending on the geometry of the machinery define, distance, trajectory, or path. Modeling the solution for calculation can be achieved in several ways, for example, being the particle under two forces one by its mass and the other force affecting it by the drag force of fluid, it may be considered to solve it by resulting force vector calculation, and given the drag force of fluid is dependent of the relative velocity of the particle to the surrounding fluid the particle will experiment a different force when starting to move and be drag than after the acceleration that the relative velocity is less, so with computing may solve it by FEA Finite Element Analysis, with advanced software, or other person may calculate the fall time giving and the drag force of lateral wind and estimate the advanced distance that may have a good precision and enough for separation.

The disclosed invention allows to concentrate or separate materials by the density of each particle in the mixture, with a physical process using, for example, only air. Minerals have different densities, and, for example, metals are heavier or higher density, with few exemptions like lithium. This process does not reach the purity or concentration of chemical process, as some of them like lixiviation work on the molecular level, but it works great to concentrate and for example concentrating with prior to chemical use may reduce chemical use, cost, and instead of producing mining tailings, the gangue of it is not chemically processed and may result in waste rock or non-toxic waste.

These and other features and advantages of the present invention will become apparent from the detailed description below, in light of the accompanying drawings.

### BRIEF DESCRIPTION OF THE DRAWINGS

The novel features which are believed to be characteristic of the present invention, as to its structure, organization, use and method of operation, together with further objectives and advantages thereof, will be better understood from the following drawings in which a presently preferred embodiment of the invention will now be illustrated by way of example. It is expressly understood, however, that the drawings are for the purpose of illustration and description only and are not intended as a definition of the limits of the invention. Embodiments of this invention will now be described by way of example in association with the accompanying drawings in which:

FIG. 1 is a schematic representation for illustrating physical principles which affect the actual invention of mineral separation by density, in accordance with an embodiment of the present invention.

FIG. 2 is a schematic representation for illustrating a practical use of the principles into a machine useful for the mineral separation, in accordance with an embodiment of the present invention.

FIG. 3 is a schematic representation for illustrating the influence of actual techniques into traditional density separator machines and how to use them in practice, in accordance with an embodiment of the present invention.

FIG. 4 is a schematic representation for illustrating a geometry of a sample separator and mathematics involved in the calculation for precise separation, in accordance with an embodiment of the present invention.

Further areas of applicability of the present invention will become apparent from the detailed description provided hereinafter. It should be understood that the detailed description of exemplary embodiments is intended for illustration purposes only and is, therefore, not intended to necessarily limit the scope of the invention.

### DETAILED DESCRIPTION OF THE INVENTION

As used in the specification and claims, the singular forms “a”, “an” and “the” may also include plural references. For example, the term “an article” may include a plurality of articles. Those with ordinary skill in the art will appreciate that the elements in the Figures are illustrated for simplicity and clarity and are not necessarily drawn to scale. For example, the dimensions of some of the elements in the Figures may be exaggerated, relative to other elements, to improve the understanding of the present invention. There may be additional components described in the foregoing application that are not depicted on one of the described drawings. In the event such a component is described, but not depicted in a drawing, the absence of such a drawing should not be considered as an omission of such design from the specification.

Before describing the present invention in detail, it should be observed that the present invention utilizes a combination of components or set-ups, which constitutes a method and a system for separating particles (of minerals or materials) from a mixture by density. The disclosed invention allows to concentrate or separate materials by the density of each particle in the mixture, with a physical process using, for example, only air. This process works great to concentrate and may reduce chemical use, cost, and instead of producing mining tailings, the gangue of it is not chemically processed and may result in waste rock or non-toxic waste. Accordingly, the components have been represented, showing only specific details that are pertinent for an understanding of the present invention so as not to obscure the disclosure with details that will be readily apparent to those with ordinary skill in the art having the benefit of the description herein.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

References to “one embodiment”, “an embodiment”, “another embodiment”, “yet another embodiment”, “one example”, “an example”, “another example”, “yet another example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

The words “comprising,” “having.” “containing,” and “including,” and other forms thereof, are intended to be equivalent in meaning and be open ended in that an item or items following any one of these words is not meant to be an exhaustive listing of such item or items or meant to be limited to only the listed item or items.

Techniques consistent with the present invention provide, among other features, a method and a system for separating the particles (having different densities but the same or similar sizes) from each other by using velocity difference of particles or objects in time that becomes distance difference and which allows separation by density. This process is aimed at reducing chemical use and its cost in the mineral separation. Unless stated otherwise, terms such as “first” and “second” are used to arbitrarily distinguish between the elements such terms describe. Thus, these terms are not necessarily intended to indicate temporal or other prioritization of such elements. While various exemplary embodiments of the disclosed system and method have been described above it should be understood that they have been presented for purposes of example only, not limitations. It is not exhaustive and does not limit the invention to the precise form disclosed. Modifications and variations are possible considering the above teachings or may be acquired from practicing of the invention, without departing from the breadth or scope.

The process of separation of particles will now be described with reference to the accompanying drawings which should be regarded as merely illustrative without restricting the scope and ambit of the present invention.

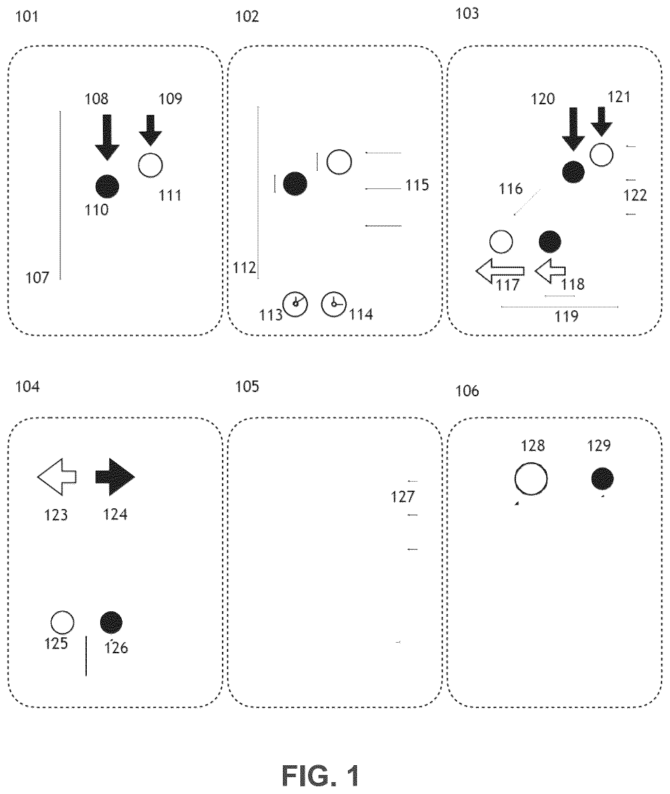

FIG. 1 shows groups of figures numbered from 101 to 106 that have been presented to explain in a progressive way the principles or processes involved in the air operated density separator. The direct counterflow is not easy to operate in small particles using air as it may suspend and blow, so this process is explained as better method in specific situations. Here, the same principle is considered which is the difference of velocity defined with stokes law. In this case, a high-density particle 110 falls faster than a low-density particle 111, given the same distance for both particles to fall or travel 107.

The particle 110 with the fastest velocity 108 will reach the bottom faster than the particle 111 with the slowest velocity 109. The same principle used in different way states that given the velocity difference, the fastest particle 110 will take a less time 113 to decent while the slower particle 111 takes longer which sounds redundant but now let's add a factor called as a lateral wind 115 intending to move both the particles in a sideway in a horizontal move, while they are decent. So, if they are of the same size, their drag force throughout the lateral wind 122 is the same, but being the slowest particle, it is dragged for more time 114. Thus, the lateral velocity which is the same for both the particles will last longer time due to the longer travel time 117, and velocity multiplied by time, makes distance and then the resulting lateral advance due to the lateral wind 122 will result longer 119 for the slowest particle 117 than the advance of the faster particle 118, given it receives the lateral wind for less time 113. Having a difference in velocity during a period the objects separate in distance, it is easy to manage them separately. It is possible to mathematically control all the process to predict the behavior of the particles in the system, for example, the height 107 might be fixed, and having the particles in a similar size or almost the same size and knowing the desired densities to separate by controlling the lateral wind 127, it can be defined the distance difference, the lateral advance will be given by the lateral velocity wind force to the particle which can be calculated by strokes law and the time of decent which can also be calculated by strokes law. For now, the description will be described just by the velocity discharging the acceleration of the particles which can also be calculated but for simplicity will remain as this for now.

In an exemplary embodiment, the materials are processed with simultaneous forces acting on particle mass and particle size. The materials are processed by free fall of particles into a side wind or gas flow, to separate the particles by density, thereby establishing the gas flow velocity to reach a distance point of separation of the materials by density. The materials are separated into lots of similar size difference to prevent mixing of bigger particles of low density with small particles of high density based on the processing of the materials. The size difference must be in a way resulting distance, trajectory, or path is affected in a higher grade by density difference of target densities of the particles to separate than size difference of the particles being processed. The materials may be allowed to fall while receiving a lateral wind of air or any gas, making the separation of the materials by density given a distance advance of the materials. The materials may be allowed to fall while receiving a lateral wind of air or any gas, making the separation of the materials by density given a path difference for the particles of the materials to follow given their behavior difference due to density difference. The materials are separated by acting forces on a particle given its mass, like gravity, centrifugal, inertia, or momentum with forces acting on it by the size like a drag force of fluids or friction, making a particular effect of the mass to size relation of the particle, which in a particle is density, establishing a distance, path, or trajectory difference given the particle density. The distance, trajectory, or path of the particles of different density may be calculated by finite element analysis. The distance, trajectory, or path of the particles of different density may be calculated by vector calculation of a resulting force and direction of the particles, when applying force acting on its mass and force acting on its size.

In some embodiments, one or more physical online sensors of minerals, i.e., x-ray frequency that can read minerals may be contented. They read the actual output, so that with database of density, can control separation by air wind velocity. Further, there are several methods to calculate a path, trajectory, or distance for the separation of the material to a specific desired density. This is very efficient and precise, but is hard to estimate, for example, the grade of liberation of the material. It does not have the same density a particle milled to 90% liberation being copper mineral particle and the rest quartz, than the same particle 50% liberation, being copper mineral and the rest 50% to be quartz, and in this case there are actually methods that sense on real time the material that is being processed, and this reading may help to know if we are losing the desired material or maybe accepting to much undesired material, the sensing of the material output with XRF Radio frequency X Ray, or other sensors in combination with computing, we can reduce the air or fluid velocity, move the physical point of separation or path, to make on time adjustments. This process can do all the work, making estimations and avoid making the described calculations, and form the reverse and make just adjustments on the processing time, although it will not work efficient unless the previous material separation is done, or physically they are mixed.

In an exemplary embodiment, the particles of materials to be separated are delivered on top of the machine at the same time (can be on slurry) and are allowed to descend. A valve is open when the heavy particles have passed through already. The light and slow particles are separated though the valve. The exact moment for valve opening defines the density cut point. In an exemplary embodiment, a user or an operator may define the specific density point for separation. For example, lithium is the lightest mineral (it depends if in sulphurs or oxidized, the mineral as they are never pure), has 2.4 gram/cm3. In that case the user or operator may set the machine at 2.5 and eliminate all the quartz, which is 2.7, but clay remained that was 10% or concentration 10 to 1 and it saves 90% of the chemicals. To do that, the user or operator may establish the distance for separation, in coordination with wind velocity and material size separation. The density point to separate may be done manually or automatic.

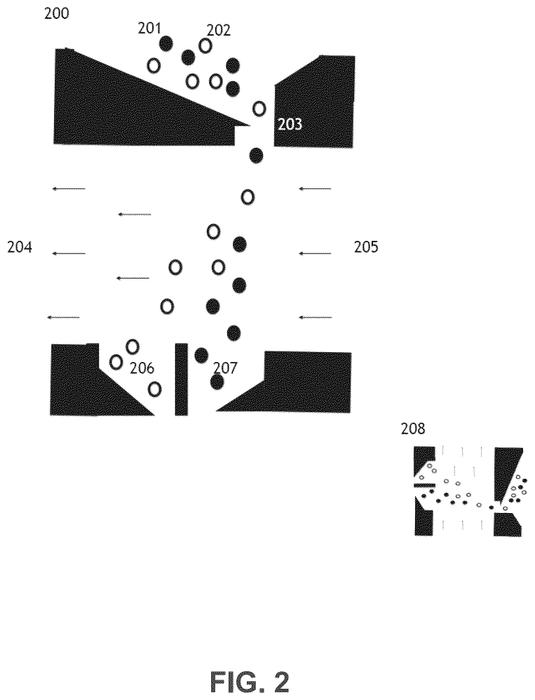

FIG. 2 shows a configuration of a dry material separation by density through fluid dynamics. Here, the materials have been pre-treated as defined in the PCT patent application “WO2019087131—MATERIAL SEPARATION BY DENSITY THROUGH FLUID DYNAMICS.” The fluid dynamics process considered here is shown by 200, where particles of different densities, for example, some high-density particles 201 (here exemplified with full black drawings) and some lower-density particles 202 (here expressed in all the drawing as black outer and white inner). These particles 201 and 202 are feed in an upper input as mixed and are provided downstream in dry form through a small hollow 203. The objective of the small hollow 203 is to provide the material in little horizontal difference so the departure is at a similar point during their vertical free fall travel, making not much difference in the lateral or horizontal advance so that the travel distance is depending in the provided horizontal wind 204, 205, as mentioned by the phenomena described in the FIG. 1. The particles or objects will be decent in vertical way having a horizontal advance that depends on density, making the lighter-density particles have more lateral advance than the higher-density particles. Having a bottom section difference for the different densities, which here are shown by a section 206 for light-density particles and a section 207 for high-density particles, thereby making the separation. The input 203 and the bottom output 206 and 207 are small compared to the lateral wind tunnel 204, 205 so the wind does not provide a turbulence affecting the wind velocity or the particles trajectory or destiny. The wind velocity can be provided either by a ventilator providing forward wind flow 205 or a ventilator fan or other pumping the wind and making the fluid movement 204 by the vacuum or negative pressure, or both to provide a steady and laminar flow that can be precisely controlled to make the process efficiently and with quality for the desired results. The actual lab test machine has free fall of less than two meter height, and winds below 3 meter per second, this not to limit the range, but giving the reader the possibility to conceptualize an industrial machine in dimensions and not make an unlimited dimension and setting it to actual possibilities and not dimensionless concept. An exemplary image of rotation of the image is given in 208 to show how similar the improvement is to the original concept of the material separation by density through fluid dynamics, being in rotation so like counter flow process described in it.

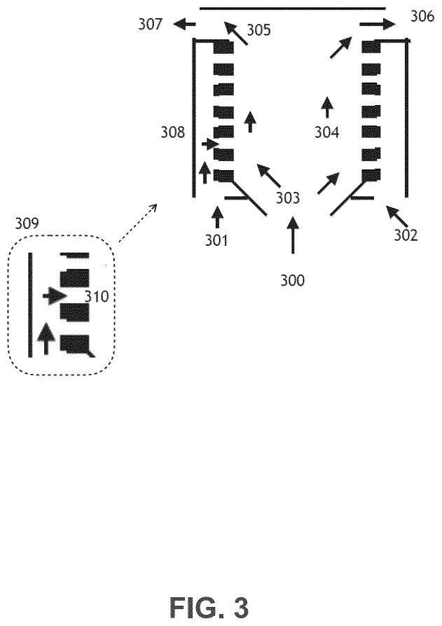

FIG. 3 is a schematic representation for illustrating the influence of actual techniques into traditional density separator machines and how to use them in practice. FIG. 3 makes a conceptual model of a traditional density concentrator as Knelson or Falcon are, where the slurry of minerals is pumped upstream while the cone rotates creating a centrifugal force that can be measured in gravity units. This forces the slurry flow to outer walls 303 while a fresh clean water is pumped inward 301 pushing a counter flow horizontal to the slurry centrifugal force that only the particles with stronger centrifugal force can pass through. As the particles to pass through it is given by the particle's physical characteristics, the centrifugal force and the drag of the fresh water incoming 301 in counter flow, as mentioned the particles capable to pass are given by the physical characteristics which can be better controlled to be dependable on density if they are previously precise size separated for desired densities and conditions. If the counter flow section 309 is zoomed and analyzed, the holes for the particles to pass have a very similar geometry or design to all fluid dynamics process described, so the precise conditions for ideal density separation can be done if there is a precise size separation done previously that makes the particles advance in that hole depending on density without important size influence, and converting the calculations into the variables affecting the phenomena which is the force (centrifugal) affecting the particle by its mass.

The clean water 301 velocity provides the force of drag that depends on size, in the counter flow hollow 310 fluid viscosity which is not commonly measured and the particles physical properties (size and density), which are not even traditionally considered but they can be obtained from the traditional operations variables measured or controlled, that are, slurry feed rate, clean water flow and machine revolutions per minute making an algorithm to know the precise behavior of particles in that area of separation 309 with the physics involved.

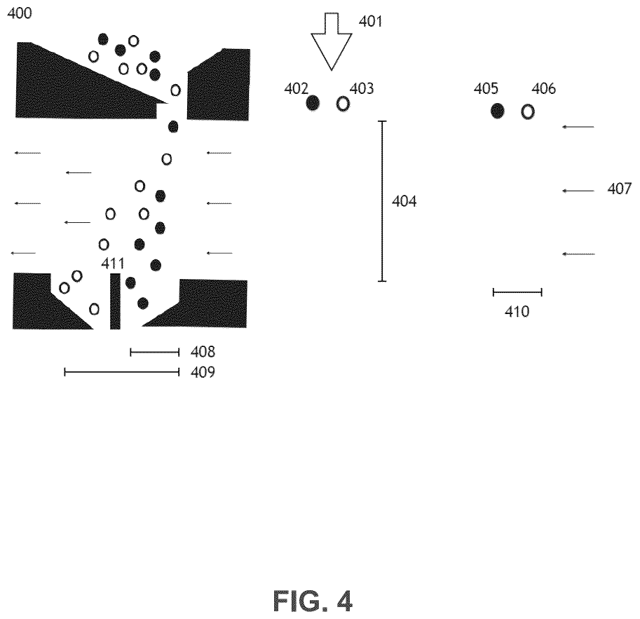

FIG. 4 shows the effect of forces in a horizontal moving fluid finding particles in its way as described previously and exemplified in diagram 400. The falling particles of heavy density 402 and low density 403 receive the gravity force 401, which is the same for both but being the same size and one particle 402 being heavier, it results in more weight, so the force is higher. Let's put it in example and say the higher-density particle 402 is 1.2 grams and lower-density particle 403 is just 1 gram. So, this is the force they exert downward, and being the same size, the heavier particle 402 falls at a faster velocity, that make it last longer to achieve the distance of the free fall 404, as it happens in the presence of fluid, in this case we will exemplify with air. In the lateral advance 410 of each particle 405, heavier or lower density 406 is given by the force the lateral fluid 407 produces in it by dragging it in lateral way, Distance=Velocity x Time, so the lateral advance 410 is given by the velocity lateral fluid 407, times the resulting time of the free fall, so it can be easily calculated. As the vertical falling time for each particle 402, 403, 405, and 406 is given by the terminal velocity of the falling particles times the distance 404 resulting in the shorter lateral advance for each one 408 for the heavier particles and the larger distance 409 for the low density particles, this can be perfectly calculated, if you have, the size and densities of the particles, the distance to separator, the fluid density and viscosity, the lateral fluid velocity, and the free fall height. This makes possible to make precision by providing a size difference of particles adequate to influence the terminal velocity in greater way by density than by size, define the separator 411 position and distance, and establish the precise lateral fluid velocity 407. This will make a very efficient separation and allows a real calculated separator, the factor that also affects but in a very small way is the acceleration the particles need to be moved, but can be easy be calculated, as we have the mass of the particles and strokes law gives the exact force particle takes under the lateral fluid effect, but was so small when calculated that for the explanation was not detailed mentioned.

Although the present invention has been described with respect to various schematic representations (FIGS. 1-4), it should be understood that the proposed particle separation methods and systems can be realized and implemented with varying shapes and sizes of particles with varying densities, and thus the present invention here should not be considered limited to the exemplary embodiments and processes described herein. The various dimensions may be modified to fit in specific application areas. Although particular embodiments of the invention have been described in detail for purposes of illustration, various modifications and enhancements may be made without departing from the spirit and scope of the invention.

1. A material separation method comprising the steps of:
processing materials with simultaneous forces acting on particle mass and particle size, wherein the materials are processed by free fall of the mass of the particles into a lateral flow of air or gas, to separate the particles by density,
isolating by mass difference the mass or the particles, the mass or the particles are previously sorted by size into fractions of smaller size,
establishing and controlling a velocity of the lateral flow of air or gas to reach a distance point of separation of the materials of lower density than a separation density desired.

2. The material separation method of claim 1, further comprising the step of allowing the materials to fall while receiving the lateral flow of the air or the gas, making the separation of the materials by density given a distance advance of the materials by calculated fluid velocity and power controlled motors for exact drag force needed for particles of lower density than separation density defined to reach the distance of separation.

3. The material separation method of claim 1, further comprising the steps of allowing the materials to fall while receiving the lateral flow of air or gas, making the separation of the materials by density given a path difference of distance.

4. The material separation method of claim 2, further comprising the step of calculating a distance, a trajectory, or a path of the particles of different density by fluid viscosity, consideration on calculation to adjust drag forces and fluid velocity, given fluid difference or climate effect on fluid viscosity.

5. The material separation method of claim 1, further comprising the step of calculating a distance, trajectory, or path of the particles of different density by finite element analysis.

6. The material separation method of claim 1, further comprising the step of calculating a distance, trajectory, or path of the particles of different density by adjusting to readings of mineral sensors.
